(19) United States
(12) Patent Application Publication
(10) Pub. No.: US 2020/0139995 A1
(43) Pub. Date: May 7, 2020

(54) SECURE LOCOMOTIVE COMMUNICATION SYSTEM

(71) Applicant: General Electric Company, Schenectady, NY (US)

(72) Inventor: Mark Elliott Loch, Erie, PA (US)

(21) Appl. No.: 16/178,896

(22) Filed: Nov. 2, 2018

(51) Int. Cl. B61L 15/00; H04L 29/08; H04L 29/06; G07C 5/00; G07C 5/08

(52) U.S. Cl. CPC B61L 15/0036; H04L 67/12; G07C 5/0808; G07C 5/008; H04L 63/0869

(57) ABSTRACT

A locomotive communication system includes a first communication device located onboard a first locomotive in a rail vehicle system formed from the first locomotive and at least a second vehicle in the rail vehicle system and a second communication device located onboard the second vehicle in the rail vehicle system, the first and second communication devices communicatively coupled with each other via a wired connection extending between the first and second communication devices. The first and second communication devices are configured to share a security credential via the wired connection. The first and second communication devices also are configured to establish a secure wireless network between the first and second communication devices using the security credential that is shared via the wired connection.

### FIELD

The subject matter described herein relates to locomotive communication systems that provide for secure communication between communication devices.

### BACKGROUND

Vehicles such as locomotives may communicate with off-board devices using wireless communication technologies. For example, locomotives in the same rail vehicle consist can communicate with each other using cellular devices, WiFi devices, radio frequency (RF) radios, or the like. These locomotives may communicate with each other via wired connections, such as over a multiple unit (MU) line, brake line, or the like. The wired connections are secure in that a device typically can communicate via the wired connection only when the device is physically connected with the wired connection. The operator(s) of the locomotives can ensure that only certain approved devices are coupled with and able to communicate over the wired connection.

But, these wired communication technologies on locomotives tend to have slower communication speeds and bandwidths when compared with the wireless communication technologies used to communicate with off-board devices. The wireless communication technologies, however, have shown to be more susceptible to attack or message interception by devices that are not approved for communication with the locomotives. As a result, the locomotives are left with a choice between slow but secure wired communications, or fast but insecure wireless communications.

### BRIEF DESCRIPTION

In one embodiment, a locomotive communication system includes a first communication device located onboard a first locomotive in a rail vehicle system formed from the first locomotive and at least a second vehicle in the rail vehicle system and a second communication device located onboard the second vehicle in the rail vehicle system, the first and second communication devices communicatively coupled with each other via a wired connection extending between the first and second communication devices. The first and second communication devices are configured to share a security credential via the wired connection. The first and second communication devices also are configured to establish a secure wireless network between the first and second communication devices using the security credential that is shared via the wired connection. A network or connection may be secure when data communicated over, through, or via the secure network or secure connection is encrypted by one or more security protocols. Optionally, a network or connection may be secure when data communicated over, through, or via the secure network or secure connection is communicated only by wired connections, regardless of whether the data is encrypted. Alternatively, a network or connection may be secure when data communicated over, through, or via the secure network or secure connection is communicated only by wired connections and the data is encrypted by one or more security protocols.

In one embodiment, a communication system includes a first communication device located onboard a first vehicle in a vehicle system formed from the first vehicle and at least a second vehicle, a second communication device located onboard the second vehicle in the vehicle system, and a first communication path extending between the first and second communication devices and established using a first communication medium. The first and second communication devices are configured to share a security credential via the first communication path. The first and second communication devices also are configured to establish a secure second communication path between the first and second communication devices using the security credential that is shared via the first communication path. The second communication path established by the first and second communication devices uses a different, second communication medium extending between the first and second communication devices.

In one embodiment, a method includes communicating a security credential between communication devices onboard different vehicles in a vehicle system. The security credential is communicated between the communication devices via a first communication path established using a first communication medium extending between the communication devices. The vehicle system is formed from at least the vehicles having the communication devices that share the security credential. The method also includes establishing a secure second communication path between the communication devices onboard the different vehicles using the security credential that is shared via the first communication path, the second communication path established using a different, second communication medium extending between the communication devices and securely communicating a data signal between the communication devices via the secure second communication path to control operation of the vehicle system.

### BRIEF DESCRIPTION OF THE DRAWINGS

The inventive subject matter may be understood from reading the following description of non-limiting embodiments, with reference to the attached drawings, wherein below:

FIG. 1 illustrates one example of a secure communication system;

FIG. 2 illustrates one example of additional communication devices joining first and second communication paths shown in FIG. 1;

FIG. 3 illustrates one example of a vehicle shown in FIG. 1; and

FIG. 4 illustrates a flowchart of one embodiment for a method of establishing a secure communication system for a locomotive-based vehicle system.

### DETAILED DESCRIPTION

One or more embodiments of the inventive subject matter described herein include communication systems that provide for secure, higher speed communications between vehicles, such as between locomotives in the same rail vehicle system. While the description herein focuses on rail vehicles (such as locomotives) and rail vehicle systems (e.g., formed from two or more rail vehicles), not all embodiments of the inventive subject matter are limited to rail vehicles or rail vehicle systems. One or more embodiments may be applied to communications between other types of vehicles, such as mining vehicles, other off-highway vehicles (e.g., vehicles that are not designed for travel on public roadways and/or that are not legally permitted for travel on public roadways), automobiles, marine vessels, or the like.

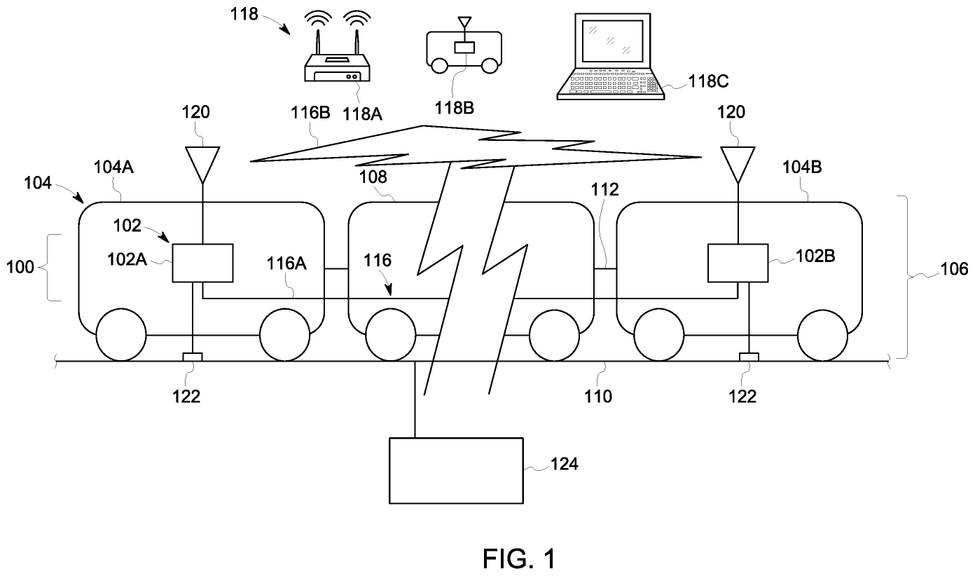

FIG. 1 illustrates one example of a secure communication system 100. The communication system 100 includes communication devices 102 (e.g., devices 102A, 102B) disposed onboard different vehicles 104 (e.g., vehicles 104A, 104B) in a vehicle system 106. The vehicles 104 may be mechanically coupled with each other in the vehicle system 106 directly or indirectly (e.g., by at least one additional vehicle 108. In one embodiment, the vehicle system 106 is a rail vehicle system and the vehicles 104, 108 are rail vehicles traveling on a route 110 that includes a track. For example, the vehicles 104 can be propulsion-generating rail vehicles (e.g., locomotives) while the vehicle(s) 108 can be one or more propulsion-generating vehicles, one or more non-propulsion-generating vehicles (e.g., rail cars, ore cars, passenger cars, etc.), or a combination of one or more propulsion-generating vehicles and one or more non-propulsion-generating vehicles. The vehicles 104, 108 are mechanically connected with each other by couplers 112. Alternatively, the vehicles 104 and/or 108 may not be mechanically coupled with each other but may be logically coupled with each other without mechanical couplings. For example, the vehicles 104 and/or 108 may be mechanically separate from each other but may communicate with each other to coordinate individual movements of the vehicles 104, 108 with each other so that the separate vehicles 104, 108 travel together along the route 110.

The communication devices 102 represent hardware circuitry that includes and/or is connected with one or more processors (e.g., one or more microprocessors, one or more field programmable gate arrays, one or more integrated circuits, and/or the like) that perform the operations described herein in connection with the communication devices 102. The communication devices 102 can include or represent transceiving circuitry such as modems, routers, antennas 120, switches, and the like. The communication devices 102 can run one or more software applications that direct the operations of the processors and/or transceiving circuitry. The communication devices 102 send and/or receive data signals or messages between the communication devices 102. One or more other pieces of equipment onboard the vehicles 104 can communicate data with each other via the communication devices 102, as described herein.

The communication devices 102 are communicatively coupled with each other by a first communication path 116 (labeled communication path 116A in FIG. 1). The first communication path 116A can be a wired connection formed of one or more cables, wires, conductive buses, or the like, that form one or more conductive pathways that extend at least between the communication devices 102. As shown, the first communication path 116A may extend through and interconnect multiple vehicles 104 and/or 108 in the vehicle system 106. Examples of such wired connections can include MU cables, brake lines, Ethernet cables, powerlines, or the like. The wired connection provides a first communication medium through or over which the communication devices 102 can send signals to and/or receive from each other. One or more additional communication devices 102 and/or other equipment also may be connected with the first communication path 116A for communication via the wired connection. For example, other equipment (described herein) can be directly connected with the first communication path 116A for communicating messages with other equipment and/or the communication devices 102. Optionally, other equipment can be indirectly connected with the first communication path 116A for communication with other equipment via the communication device(s) 102. For example, equipment onboard one vehicle 104A can provide signals to the communication device 102A, which can then send the signals via the first communication path 116 to the communication device 102B. The communication device 102B can then send the signals to the equipment to which the signals are addressed. Alternatively, the communication device 102A can directly send the signals via the first communication path 116A to the equipment without being first sent to the communication device 102B.

In operation, the communication devices 102 share a security credential via the first communication path 116. The security credential can be some information or data indicating that the communication device 102 sending or possessing the security credential is a secure, authorized, and/or previously selected device for communicating with another device. For example, prior to sharing a security credential, the communication device 102A may not communicate with the communication device 102B, such as by the communication device 102B not having the encryption key used by the communication device 102A to encrypt signals sent by the communication device 102A, by not receiving or ignoring signals received from the communication device 102B, by not sending signals to the communication device 102B, by not providing a network identifier (e.g., network address) to the communication device 102B, by not providing authentication information (e.g., a login and password combination), or the like.

As described herein, the security credential can be shared between the communication devices 102 via the first communication path 116 of a first type of communication medium (e.g., conductive pathways) and then used by the communication devices 102 to establish, create, and/or otherwise begin communicating over a second communication path 116B between the communication devices 102. This second communication path 116B can be embodied in a different type of medium than the first communication path 116A. For example, the first communication path 116A can be a wired communication path (e.g., formed of one or more conductive bodies) while the second communication path 116B is a wireless communication path (e.g., formed of transient electromagnetic waves). Alternatively, the first communication path 116A may be a wireless communication path and the second communication path 116B can be a wired communication path. In another embodiment, both the first and second communication paths 116A, 116B are wired communication paths. Or, both the first and second communication paths 116A, 116B can be wireless communication paths.

The first communication path 116A can be a pre-existing conductive pathway (e.g., a pre-existing cable extending along the length of the vehicle system 106) that also is used to communicate one or more data signals between the vehicles 104 in the vehicle system 106. For example, the first communication path 116A can be a power line (e.g., a 74 Vdc line) or an electronically controllable pneumatic brake line (e.g., a 230. Vdc line) and the communication devices 102 can use Ethernet over power line communication to communicate using the first communication path 116A. As another example, the first communication path 116A can be an MU line of a train and the communication devices 102 can use Ethernet over MU line communication to communicate using the first communication path 116A.

The first communication path 116A can be a slower communication path than the second communication path 116B and/or introduce increased amounts of electromagnetic noise into signals communicated via the first communication path 116A than signals communicated via the second communication path 116B. For example, even though some of these types of communication paths 116A may use Ethernet technology to communicate, this type of communication of these types of communication paths 116A can be slower, have reduced bandwidth, have increased electromagnetic noise, and/or be less reliable than wireless communications. For example, cellular modems, WiFi modems and routers, RF radios, and the like, can wirelessly communicate via the second communication path 116B (e.g., a 220 MHz radio communication path, a wireless Ethernet network, etc.) at faster speeds (e.g., more bits, kilobits, or bytes per second), increased bandwidths (e.g., larger ranges of frequencies can be used for the carrier signals used for communication), with reduced electromagnetic noise, and/or with greater reliability.

The communication devices 102 can share a security credential by at least one of the communication devices 102 communicating the security credential to the other communication device 102 via the first communication path 116A. The security credential can be communicated via the first communication path 116A because the first communication path 116A is more secure than the second communication path 116B in at least one embodiment of the subject matter described herein. For example, the first communication path 116A may not be accessible by any other communication devices 118 (e.g., communication devices 118A-C in FIG. 1) that are not onboard the vehicle system 106. These other communication devices 118 can include a wireless router 118A, a communication device 118B (e.g., another communication device 102) onboard another vehicle 104 that is not in the vehicle system 106, a computer 118C having wireless communication capabilities, and the like. Because none of the communication devices 118 is connected with the first communication path 116A (e.g., by a connector or hard-wired connection), the communication devices 118 cannot communicate with the communication devices 102 and/or other equipment onboard the vehicle system 106 via the first communication path 116A.

The communication device 102A can send a signal containing a security credential to the communication device 102B via the first communication path 116A. Because the communication devices 118 are not connected with the first communication path 116A, the communication devices 118 cannot receive the security credential. The security credential can include information that is used by the communication devices 106A, 106B having the security credential to establish or join the second communication path 116B. For example, the security credential can include an encryption key used by the communication devices 102 to encrypt and decrypt wirelessly communicated messages sent via the second communication path 116B. As another example, the security credential can include a login and/or password that is required to access a wireless communication network that includes or is represented by the second communication path 116B. As another example, the security credential can include a network address of another communication device 102. For example, the communication device 102A can provide the network address of the communication device 102A to the communication device 102B as a security credential and the communication device 102B can provide the network address of the communication device 102B to the communication device 102A as a security credential.

In one embodiment, the security credential is communicated via the first communication path 116A without encrypting the security credential. Because the first communication path 116A is inaccessible to devices 118 that are off-board the vehicle system 106, the security credential can be communicated using the first communication path 116A without encrypting the security credential as the first communication path 116A may be a secure communication path due to the inaccessibility of the first communication path 116A. Alternatively, the security credential can be communicated using an encrypted signal send via the first communication path 116A.

The communication devices 102 use the shared security credential(s) to establish the second communication path 116B. The second communication path 116B can be established by the communication devices 102 beginning to wirelessly communicate with each other using or based on the security credential. For example, the communication devices 102 may begin communicating encrypted messages with each other via the second communication path 116B using the shared encryption key. As another example, the communication devices 102 may use the login and password to access the wireless network that includes or is formed by the second communication path 116B. As another example, the communication devices 102 can send messages to the network addresses of each other using the second communication path 116B. Because other devices 118 that did not receive or otherwise share the security credential do not have the security credential, these devices 118 are unable to communicate with the communication devices 102 using the second communication path 116B.

The communication devices 102 can establish and/or use the second communication path 116B without sharing network identifying information over or through the second communication path 116 and/or without broadcasting any network identifying information. The communication devices 102 may not wirelessly broadcast a network identifier of any of the communication devices 102 in one embodiment. For example, the communication devices 102 may not wirelessly broadcast a network address of any communication devices 102 connected to the wireless network that is represented by the second communication path 116B. The communication devices 102 may not wirelessly broadcast a network access identifier, name, or other identity of any communication devices 102 connected to the wireless network that is represented by the second communication path 116B. Additionally, or alternatively, the communication devices 102 may not wirelessly broadcast a network identifier of the wireless network that is represented by the second communication path 116B. For example, the communication devices 102 may not wirelessly broadcast a network address of any device connected to the wireless network that is represented by the second communication path 116B. The communication devices 102 may not wirelessly broadcast a network access identifier, name, or other identity of any device connected to the wireless network that is represented by the second communication path 116B. Withholding and not sharing the network identifier information associated with the second communication path 116B can provide for increased security for the second communication path 116B as other devices 118 may not be able to identify or find the second communication path 116B without this information.

In one embodiment, the first communication path 116A is not a pre-existing cable extending through the vehicle system 106 but is a conductive portion of the route 110. For example, the route 110 can be a track formed from one or more conductive rails. The communication devices 102 can include conductive bodies 122 (e.g., conductive shoes, brushes, or the like) that engage at least one of the conductive rails to inject signals into the rail(s) and to receive signals conducted through the rail(s). The signals can be conducted through the rail(s) from the conductive body 122 of one communication device 102 to the conductive body 122 of another communication device 102 to permit these communication devices 102 to share the security credential.

Optionally, the security credential can be obtained from an off-board device 124. The off-board device 124 can represent one or more wayside devices disposed alongside or near the route 110. The off-board device 124 can be part of a positive train control system, a signal, a gate, or the like, that is conductively coupled with the conductive portion of the route 110. The off-board device 124 can include one or more communication devices that can inject a signal containing a security credential into the conductive portion(s) of the route 110. This signal can be received by the communication devices 102 via the conductive bodies 122 and the security credential can then be used to establish and begin communicating via the second communication path 116B.

One or more of the communication devices 102 can update the security credential that is used for communicating via the second communication path 116B. For example, the communication device 102A may send an updated, new, and/or different security credential to the communication device 102B on a periodic basis, an aperiodic basis, or at random times. Upon sharing of this updated, new, and/or different security credential, the communication devices 102 can re-establish communicating over the second communication path 116B using the updated, new, and/or different security credential. Changing the security credential can further increase the security of communications sent using the second communication path 116B as any device 118 attempting to communicate over or intercept communications sent over the second communication path 116B would need to repeatedly be able to decipher the changing security credentials. Alternatively, the security credential is not updated, replaced, or changed. For example, the same security credential can be used for an entire trip of the vehicle system 106 from a starting location where the vehicles 104, 108 are coupled with each other to another location where the vehicles 104, 108 are separated from each other.

The sharing of the security credential and/or the formation of the second communication path 116B can occur automatically. For example, responsive to a communication device 102 being connected to the first communication path 116A, the communication device 102 can communicate a request signal to other communication devices 102 that also are connected to the first communication path 116A. This request signal can be received by the other communication device(s) 102 and the other communication device(s) 102 can respond with a signal that includes the security credential. Because only approved communication devices 102 that are onboard the vehicle system 106 can connect to the first communication path 116A, the security credential can be shared with communication devices 102 as the communication devices 102 connect with the first communication path 116A.

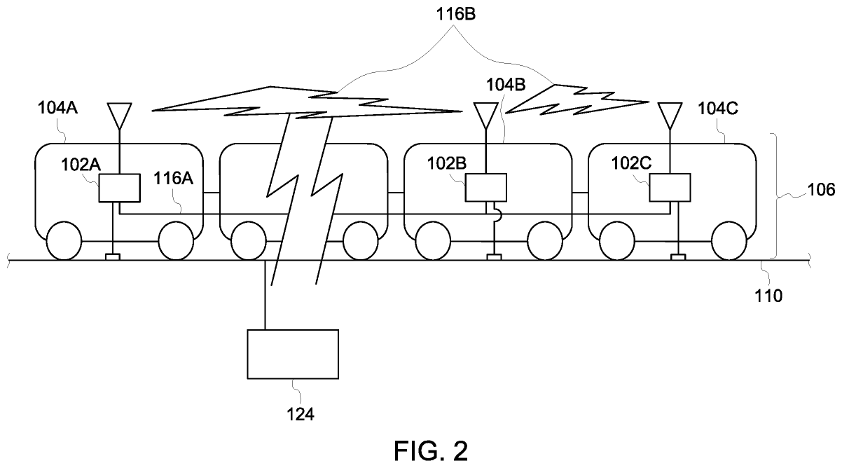

FIG. 2 illustrates one example of additional communication devices 102 joining the first and second communication paths 116 shown in FIG. 1. In operation, an additional communication device 102 (e.g., communication device 102C in FIG. 2) can connect with the first communication path 116A. This can occur during the process of adding another vehicle 104 (e.g., vehicle 104C in FIG. 2) to the vehicle system 106. The communication device 102C can be connected with the first communication path 116A as the vehicle 104C is added to the vehicle system 106. The communication device 102C can send a request signal along the first communication path 116A after the communication device 102C is connected to the first communication path 116A. Another communication device 102 (e.g., the communication device 102A and/or 102B) having the security credential can then send the security credential to the newly joined communication device 102C. The communication device 102C can then join or establish the second communication path 116B and communicate with the other communication devices 102 via the second communication path 116B using the security credential that was shared.

Optionally, the communication device 102A and/or 102B can send a new, updated, or modified security credential to the newly joined communication device 102C. The communication device 102A and/or 102B also can send this same new, updated, or modified security credential to the other communication devices 102. For example, responsive to a new communication device 102C connecting with the first communication path 116A, the communication device 102B can send an updated security credential to the new communication device 102C and to the communication device 102A that already was communicating with the communication device 102B via the second communication path 116B. The communication devices 102A-C can then join or establish the second communication path 116B using the new security credential.

The sharing of the security credential with the communication device 102C that is added to a pre-existing network of communication devices 102 communicating on the second communication path 116B can occur automatically (e.g., without operator intervention). For example, the added communication device 102C can be programmed to automatically send the request signal on the first communication path 116A responsive to connecting with the first communication path 116A. As another example, the communication device 102A and/or 102B can detect the added communication device 102C connecting to the first communication path 116A. The communication device 102A and/or 102B can then share the security credential with the added communication device 102C responsive to detecting the connection.

In one embodiment, the second communication path 116B communicates data signals at faster rates, at greater bandwidths, and/or with reduced electromagnetic noise relative to data signals communicated in the first communication path 116A. For example, the communication devices 102 can communicate data between each other via the second communication path 116B at more bits or bytes per second than the first communication path 116A. As another example, the communication devices 102 can communicate data between each other via the second communication path 116B using a larger range of carrier range frequencies than are available using the first communication path 116A (e.g., due to the greater bandwidth of the second communication path 116B). As another example, the communication devices 102 can communicate data between each other via the second communication path 116B with a lower error rate than occurs while using the first communication path 116A (e.g., due to the greater noise using the first communication path 116A).

The communication system 100 can utilize the improved communications over the second communication path 116B relative to the first communication path 116A for a variety of different purposes, as described herein.

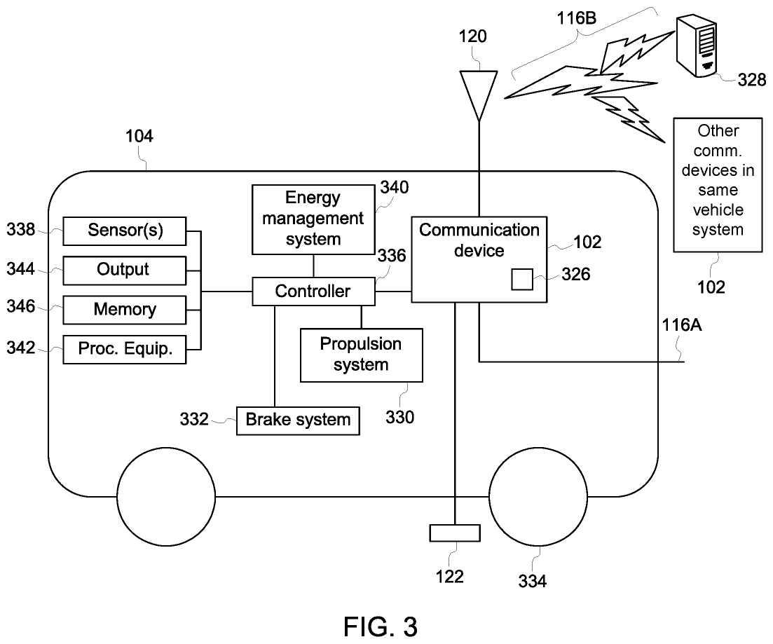

FIG. 3 illustrates one example of one of the vehicles 104 shown in FIG. 1. The vehicle 104 includes the communication device 102 that operates based on one or more software applications 326. These software application(s) 326 can translate data received from other equipment into data signals and/or send these data signals via the communication paths 116 to one or more other pieces of equipment and/or communication devices 102. The software application(s) 326 may require updates or modifications to the machine code forming the software application(s) 326. For example, the communication device 102 can receive a notification signal from one or more off-board devices 328 (e.g., servers, data storage facilities, or the like, that also may have security credentials for communicating via the second communication path 116B).

This notification signal may direct a download of a new software application 326, an update to an existing software application 326 already installed in memory of the communication device 102, and/or another change to the software application 326. The memory of the communication device 102 also can be represented by 326 in FIG. 3. The communication device 102 may download the new software application 326, update to the software application 326, or other change to the software application 326 over or through the second communication path 116B responsive to receiving this notification signal. Optionally, the communication device 102 may periodically send a query signal via the second communication path 116B to the off-board device to determine whether a new, updated, or changed software application 326 is available and to download the new, updated, or changed software application 326.

The new software application 326, update to the software application 326, and/or other change to the software application 326 can be downloaded by the communication device 102 via the second communication path 116B. The data downloaded for the new, updated, and/or changed software application 326 can be downloaded at a much faster rate (e.g., in terms of bits or bytes per second) from the off-board device 328 via the second communication path 116B than the first communication path 116A. Optionally, the data downloaded for the new, updated, and/or changed software application 326 can be downloaded at a much faster rate (e.g., in terms of bits or bytes per second) from the off-board device 328 via the second communication path 116B than another less secure wireless communication path. For example, another wireless communication path may have many other devices using that path for communication (including devices that do not have the security credential used to access or establish the second communication path 116B). This can significantly reduce the rate at which data can be downloaded by the communication device 102 relative to downloading the data via the second communication path 116B.

Additionally, the second communication path 116B can allow for multiple communication devices 102 that are connected to and/or otherwise have access to the second communication path 116B to download the data for the new, updated, and/or changed software application 326 faster than if these communication devices 102 obtained this data via another communication path. For example, the communication devices 102 may not be able to download this data as quickly via the first communication path 116A and/or via a less secure wireless communication path. This can permit the communication devices 102 onboard the same vehicle system 106 (shown in FIG. 1) to download the data for the new, updated, and/or changed software application much faster than these communication devices 102 currently are able to. Optionally, the second communication path 116B can permit multiple or all communication devices 102 onboard the same vehicle system 106 to securely and simultaneously download the data for the new, updated, and/or changed software application.

Currently, some known vehicle systems are restricted to having the communication devices onboard the vehicle system individually download this data via the slower first communication path 116A. Having the communication devices 102 simultaneously or concurrently download the data for the new, updated, and/or changed software application can speed up the installation of this data on the different vehicles 104 and can permit the vehicle system 106 to return to operations not involving the installation of this data more quickly.

The vehicle 104 also includes a propulsion system 330 and a brake system 332. The propulsion system 330 can include equipment that operates to generate tractive effort to propel the vehicle 104. For example, the propulsion system 330 can include one or more engines, alternators, generators, batteries or other energy storage devices (e.g., capacitors, flywheels, etc.), and/or motors that operate to rotate wheels 334 of the vehicle 104. The brake system 332 can include equipment that operates to generate braking effort to slow or stop movement of the vehicle 104. For example, the brake system 332 can include one or more friction brakes, regenerative brakes (e.g., motors), or the like, that slow or stop rotation of the wheels 334. Optionally, the brake system 332 may be part of the propulsion system 330. The motor(s) that propel the vehicle 104 for the propulsion system 330 also can use regenerative braking to slow or stop movement of the vehicle 104.

A controller 336 of the vehicle 104 controls operation of the propulsion system 330 and/or the brake system 332 to control movement of the vehicle 104. The controller 336 represents hardware circuitry that includes and/or is connected with one or more processors that perform the operations of the controller 336. The controller 336 can receive input from an operator of the vehicle 104 (e.g., manual actuation of a throttle, pedal, lever, button, touchscreen, or the like) and can change the tractive effort and/or braking effort created by the propulsion system 330 and/or brake system 332 to implement the operator-directed change in movement of the vehicle 104. The controller 336 optionally can receive control signals via the communication device 102 from another vehicle 104 in the same vehicle system 106 and/or from other equipment (onboard or off-board the vehicle system 106). These control signals may direct the controller 336 to change operation of the vehicle 104. For example, a controller onboard another vehicle 104 in the same vehicle system 106, an operator onboard another vehicle 104 in the same vehicle system 106, an energy management system (described below) onboard another vehicle 104 in the same vehicle system 106, the off-board device 124 (shown in FIG. 1), or the like, can communicate control signals to the controller 336 shown in FIG. 3 via the second communication path 116B and the communication devices 102. The controller 336 that receives the control signals can implement changes to the movement of the vehicle 104 according to directions contained in the control signals.

In one embodiment, each controller 336 onboard the vehicle system 106 can individually determine operational settings of the vehicle 104 on which the controller 336 is disposed and implement changes to the movement of the vehicle 104 according to the determine operational settings. Currently, some known vehicle systems have a main controller onboard one propulsion-generating vehicle that determines and changes the operational settings for other propulsion-generating vehicles based on trip information. This main controller receives relevant trip information from sensors, operators, off-board devices, or the like, to determine how to change the operational settings of the propulsion-generating vehicles the vehicle system. The trip information can include warning about objects blocking the route 110 (shown in FIG. 1), changes in upcoming speed limits, upcoming curves in the route 110, upcoming changes in grades in the route 110, etc.

Because the existing wired connections on these vehicle systems may be too slow for sharing this trip information with the controllers onboard the other vehicles to allow the controllers to individually determine how to change the operational settings of the corresponding vehicles, only the main controller determines the changes to operational settings for all vehicles in the vehicle system. Otherwise, the delay in sharing the same trip information could result in different controllers receiving the trip information at different times. This can result in one or more controllers receiving the trip information too late (e.g., after the conditions represented by the trip information have changed). Consequently, only one main controller is responsible for obtaining the trip information and determining the operational settings for all vehicles in the vehicle system.

Sensors 338 onboard different vehicles 104 can sense trip information, off-board devices 124 can provide trip information, and the like, and can share the trip information with multiple or all controllers 336 via the second communication path 116B. The sensors 338 can represent cameras, radar systems, antennas, radio frequency identification tag readers, location sensors (e.g., global positioning system receivers), accelerometers, or the like, that determine trip information about the vehicles 104. The faster communication rates and/or greater bandwidth of the second communication path 116B can permit for this trip information to be shared with the controllers 336 much more quickly than the first communication path 116A. This can allow for the controllers 336 to receive and examine the trip information, and individually determine changes to operational settings of the corresponding vehicle 104. The controllers 336 may not need to only obey commands provided by the master controller but can individually and separately determine the operational settings for the corresponding vehicles 104. For example, if the trip information indicates that an object is on the route 110 ahead of the vehicle system 106, this information can be shared with the controllers 336 via the second communication path 116B and the communication devices 102, and the controllers 336 can individually determine whether to engage the brake system 332 or reduce a throttle setting of the propulsion system 330. This determination may differ based on where the corresponding vehicle 104 is located in the vehicle system 106 to ensure the forces exerted on the couplers 112 (shown in FIG. 1) does not exceed predefined safety limits. Allowing the controllers 336 to individually determine the operational settings of the corresponding vehicle 104 makes the controllers 336 less reliant or not reliant on a single controller to provide the operational settings.

Optionally, the controller 336 can communicate with an energy management system 340 that determines the operational settings for the vehicles 104 in the vehicle system 106. The energy management system 340 represents hardware circuitry that includes and/or is connected with one or more processors. One or more of the processors of the communication device 102, the controller 336, and/or the energy management system 340 may be the same processor. The energy management system 340 examines trip data and/or trip information to create a trip plan. The trip data can include designated characteristics of an upcoming trip of the vehicle system 106 that are not obtained from the sensors 338, such as a distance of the trip, grades in the route 110, curves in the route 110, speed limits of the route 110, weight of cargo being carried by various vehicles 104 in the vehicle system 106, the number and/or arrangement of the vehicles 104 and/or 108 in the vehicle system 106, a schedule by which the trip is to be completed, planned occupancies of the route 110 by other vehicles or vehicle systems, etc. The trip information can be sensed data obtained by the sensors 338.

The energy management system 340 determines planned operational settings of the vehicle system 106 at different locations, distances along the route 110, and/or times of the upcoming trip. These operational settings can be referred to as a trip plan. For example, the energy management system 340 can designate or dictate throttle settings, brake settings, speeds, or the like, of the vehicle system 106 as a function of one or more of time, location, and/or distance along the route 110. These settings can be determined by the energy management system 340 to achieve one or more goals, such as to reduce the amount of fuel or energy consumed by the vehicle system 106 during the trip (while arriving within a designated scheduled time at one or more locations), reducing emissions generated by the vehicle system 106 (while arriving within a designated scheduled time at one or more locations), reducing forces exerted on the couplers 112 and/or vehicles 104, 108 (while arriving within a designated scheduled time at one or more locations), or the like, relative to the vehicle system 106 traveling according to other operational settings, such as the operational settings that cause the vehicle system 106 to travel at the speed limits(s) of the route 110.

The energy management system 340 can update or otherwise modify the trip plan during travel of the vehicle system 106. For example, the trip plan may be adjusted due to equipment failure of one or more vehicles 104, due to an unexpected problem with the route 110, due to a change in the trip schedule, or the like. The energy management system 340 can obtain data from the sensors 338 onboard other vehicles 104, 108 in the vehicle system 106 and updated the trip plan based on this data. Because the sensor data can be communicated to the energy management system 340 and/or the energy management system 340 can communicate the trip plan and changes to the trip plan to the controllers 336 via the speed second communication path 116B, the energy management system 340 can receive the sensor data, send the trip plan, and/or send updates to the trip plan at faster speeds than would be available using the first communication path 116A. This may permit the trip plan to be updated and sent to the controllers 336 on a more frequent basis due to the faster communication speeds of the second communication path 116B.

As described above, one or more of the sensors 338 may include a camera that generates video data and/or image data indicative of events occurring within a field of view of the camera. The higher speed second communication path 116B can be used to transfer this camera data to equipment (e.g., controllers 336, energy management systems 340, other processing equipment 342, etc.) onboard vehicles 104 other than the vehicle 104 having the camera. The limited bandwidths and/or the limited data transfer rates of the first communication path 116A may be insufficient to transfer the camera data and/or to transfer the camera data within an operationally reasonable time period. The operationally reasonable time period can be a time in which the sensor data is still useful for operation of the vehicle system 106. With respect to cameras, the operationally reasonable time period may be the time period between the time at which an object appears in the data output by a camera and the time at which a controller 336 must act to avoid colliding with the object and/or the time at which the object no longer appears in the data output by the camera. The second communication path 116B, however, may be able to communicate the camera data to the equipment onboard other vehicles 104 within the operationally reasonable time period so that this equipment can examine and/or act on the camera data before the camera data is no longer relevant.

The sensor data can be communicated via the second communication path 116B to equipment onboard another vehicle 106 for display on an output device 344 (e.g., an electronic display), for storage in a tangible and non-transitory computer readable memory 346 (e.g., a computer hard drive, removable drive, or the like), and/or for examination and use by processing equipment 342. The processing equipment 342 can represent one or more different computerized processing systems that examine the sensor data to perform one or more actions and/or to complete one or more analyses on the data to assist in controlling and/or monitoring operation of the vehicle 104 and/or vehicle system 106.

In one embodiment, the second communication path 116B can be used by the vehicle system 106 to assist a vehicle 104 with performing an operation of the vehicle 104 after processing equipment 342 on the vehicle 104 fails. For example, the processing equipment 342 onboard the vehicle 104A may rely on location data obtained from a global positioning system receiver as the sensor 338 onboard the vehicle 104A. Responsive to the processing equipment 342 onboard the vehicle 104A failing or otherwise being unable to use the sensor data to perform one or more operations, the communication device 102B onboard another vehicle 104B may send the same type of sensor data (e.g., location data) from a similar sensor 338 (e.g., another global positioning system receiver) that is onboard another vehicle 104B to the processing equipment 342 onboard the vehicle 104A. This sensor data can be rapidly communicated to the processing equipment 342 onboard the vehicle 104A via the second communication path 116B. Because the second communication path 116B is able to quickly send the sensor data, the loss of fidelity or degree of match in the sensor data from the sensor 338 onboard the vehicle 104B would be reduced (relative to communicating this sensor data via the first communication path 116A). For example, the sensor data may be able to be communicated from the vehicle 104B to the processing equipment 342 on the vehicle 104A via the second communication path 116B so quickly that the sensor data may appear to be from or may be as precise as the sensor data from the sensor 338 onboard the vehicle 104A. The processing equipment 342 on the vehicle 104A can then perform the operation(s) using the sensor data as if the operations were performed using sensor data from the sensor 338 onboard the same vehicle 104A.

As another example, the processing equipment 342 can include or represent another communication device, such as a radio used to communication with off-board devices 124. In one embodiment, the processing equipment 342 includes a 220 MHz radio (or other wireless communication device) used to communicate with off-board safety systems, such as a positive train control system. The radio can receive wireless signals from the off-board device 124 that warns the vehicle system 106 of obstructions of the route 110, slow orders, maintenance of the route 110, speed limits, requirements to engage brakes, etc. The radio can send this information to the controller 336, which can automatically control movement of the vehicle 104 to abide by the instructions received from the off-board device 124.

In one embodiment, the radio onboard one vehicle 104B may fail or otherwise be unable to communicate with the off-board device 124. The communication system 100 (shown in FIG. 1) can switch to using a radio onboard another vehicle 104A to receive the wireless signals from the off-board device 124. These signals can be communicated to the controller 336 onboard the vehicle 104B having the failed radio via the second communication path 116B to prevent the failed radio on the vehicle 104B from interfering with or preventing safe operation of the vehicle system 106.

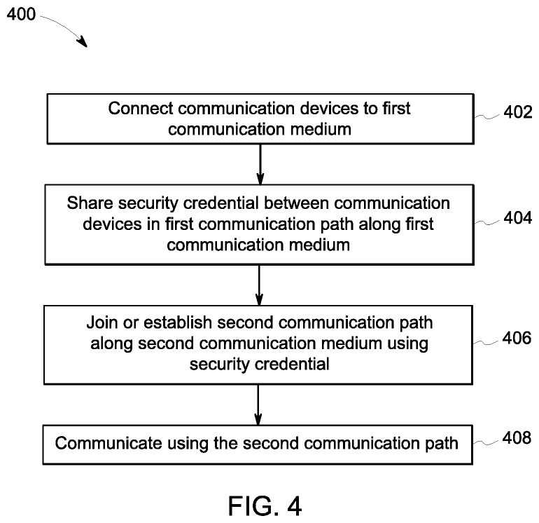

FIG. 4 illustrates a flowchart of one embodiment for a method 400 of establishing a secure communication system for a locomotive-based vehicle system. The method 400 can describe the operations performed by the communication devices disposed onboard locomotives of a rail vehicle system. Alternatively, the method 400 can describe the operations performed by communication devices disposed onboard another type of vehicle. At 402, communication devices are connected with a first communication medium. The communication devices can be connected with a wired connection extending along the length of the vehicle system, such as a cable extending between the locomotives on which the communication devices are disposed. This first communication medium can be used as a first communication path between the communication devices. As described herein, this communication path may have slow data transfer speeds, limited bandwidth, and/or be more susceptible to electromagnetic noise.

At 404, the communication devices can share a security credential with each other via the first communication medium. For example, one communication device can send the security credential to another communication device through the cable extending between the communication devices. At 406, this security credential is used to join or establish a second communication path in a second communication medium. For example, the communication devices can create or join a wireless communication network using the security credential that is shared over the first communication medium. This second communication path may have faster data transfer rates, larger communication bandwidth, and/or less noise than the first communication path.

At 408, the communication devices communicate with each other using the second communication path. The communication devices can communicate with each other to share sensor data, to individually control vehicles in the vehicle system, to allow equipment on one vehicle serve as a remote replacement for failed equipment on another vehicle, and the like.

In an embodiment, a communication system (e.g., a train or locomotive communication system, or a communication system for another vehicle system, such as an on-road platoon of semi-trailer trucks) includes a first communication device located onboard a first vehicle in a vehicle system formed from the first vehicle and at least a second vehicle in the vehicle system. The system also includes a second communication device located onboard the second vehicle in the vehicle system. Initially, the first and second vehicles come together for electro-mechanical coupling (e.g., by an electrical cable), such that the first and second communication devices are communicatively coupled with each other via a wired connection extending between the first and second communication devices. When so connected, the first and second communication devices are configured to share a security credential via the wired connection. The first and second communication devices also are configured to establish a secure wireless network between the first and second communication devices using the security credential that is shared via the wired connection. The wireless network may be established before the wired connection is disconnected, or it may be established after the wired connection is disconnected, but in either case, the wireless network continues operation after the first vehicle and the second vehicle are mechanically disconnected from one another. The wireless network may be used by the vehicles to communicate control commands for one of the vehicles to control the other vehicle for coordinated movement along a route, without there being a mechanical connection between the vehicles. The secure wireless network may be similarly established between additional vehicles, e.g., one vehicle is sequentially connected to plural other vehicles via a wired connection, or the plural vehicles are interconnected to one another (e.g., in series) via a wired connection which is disconnected before the vehicles commence coordinated travel along a route.

In an embodiment, a communication system (e.g., for a locomotive or train, or for other vehicles) includes a first communication device configured to be located onboard a first vehicle in a vehicle system formed from the first vehicle and at least a second vehicle. The first communication device is configured to communicate, using a first communication medium over a first communication path extending between the first communication device and a second communication device located onboard the second vehicle in the vehicle system, with the second communication device. The first communication device is configured to share a security credential via the first communication path with the second communication device. The first communication device is also configured to establish a secure second communication path between the first and second communication devices using the security credential that is shared via the first communication path. The second communication path is established by the first communication device using a different, second communication medium extending between the first and second communication devices.

In one embodiment, a locomotive communication system includes a first communication device located onboard a first locomotive in a rail vehicle system formed from the first locomotive and at least a second vehicle in the rail vehicle system and a second communication device located onboard the second vehicle in the rail vehicle system, the first and second communication devices communicatively coupled with each other via a wired connection extending between the first and second communication devices. The first and second communication devices are configured to share a security credential via the wired connection. The first and second communication devices also are configured to establish a secure wireless network between the first and second communication devices using the security credential that is shared via the wired connection.

Optionally, the first and second communication devices are configured to securely communicate a data signal between the first and second communication devices via the secure wireless network to control operation of the vehicle system.

Optionally, the wired connection includes a multiple unit cable.

Optionally, the wired connection includes a portion of a conductive portion of a track on which the rail vehicle system is positioned.

Optionally, the first and second communication devices are configured to establish the secure wireless network without the first or second communication device broadcasting identifying information about the first or second communication device or about the wireless network.

Optionally, at least one of the first or second communication devices is configured to communicate one or more of the security credential or an updated security credential to the one or more additional communication devices via the wired connection to connect the one or more additional communication devices to the secure wireless network using the one or more of the security credential or the updated security credential responsive to one or more additional rail vehicles having an additional communication device connecting with the rail vehicle system and with the wired connection.

In one embodiment, a communication system includes a first communication device located onboard a first vehicle in a vehicle system formed from the first vehicle and at least a second vehicle, a second communication device located onboard the second vehicle in the vehicle system, and a first communication path extending between the first and second communication devices and established using a first communication medium. The first and second communication devices are configured to share a security credential via the first communication path. The first and second communication devices also are configured to establish a secure second communication path between the first and second communication devices using the security credential that is shared via the first communication path. The second communication path established by the first and second communication devices uses a different, second communication medium extending between the first and second communication devices.

Optionally, the first and second communication devices are configured to securely communicate a data signal between the first and second communication devices via the secure second communication path to control operation of the vehicle system.

Optionally, the security credential that is communicated via the first communication path is an encryption key.

Optionally, the first communication medium is a conductive connection between the first and second communication devices.

Optionally, the first communication path extends through and includes an off-board communication device.

Optionally, the second communication medium used to establish the second communication path is a wireless network.

Optionally, the first and second communication devices are configured to establish the secure second communication path without the first or second communication device broadcasting identifying information about the first or second communication device.

Optionally, the first and second communication devices are configured to establish the secure second communication path without the first or second communication devices wirelessly broadcasting (a) a network identifier of any of the first or second communication devices or (b) a network identifier of a wireless network that connects the first and second communication devices.

Optionally, the second communication path communicates data at one or more of faster data speeds or over larger data bandwidths than the first communication path.

In one embodiment, a method includes communicating a security credential between communication devices onboard different vehicles in a vehicle system. The security credential is communicated between the communication devices via a first communication path established using a first communication medium extending between the communication devices. The vehicle system is formed from at least the vehicles having the communication devices that share the security credential. The method also includes establishing a secure second communication path between the communication devices onboard the different vehicles using the security credential that is shared via the first communication path, the second communication path established using a different, second communication medium extending between the communication devices and securely communicating a data signal between the communication devices via the secure second communication path to control operation of the vehicle system.

Optionally, the method also includes concurrently updating one or more of stored data or software operating on the communication devices using a data update communicated to the communication devices via the second communication path.

Optionally, the method also includes receiving trip data at the communication devices via the second communication path. The trip data can indicate information on an upcoming trip or segment of a current trip of the vehicle system. The method also can include separately and individually determining operational settings of the vehicle systems based on the trip data. The operational settings can be determined separately and individually by a controller onboard each of the vehicles. The method also can include implementing the operational settings that are separately and individually determined by the controllers onboard the vehicles to change movement of the vehicle system.

Optionally, the method also includes obtaining visual data from one or more cameras onboard a first vehicle of the vehicles in the vehicle system and communicating the visual data from the one or more cameras onboard the first vehicle to one or more of a display device or a tangible and non-transitory computer-readable memory located onboard a different, second vehicle of the vehicles in the vehicle system via the second communication path.

Optionally, the method also includes detecting a failure of first equipment that is located onboard a first vehicle of the vehicles in the vehicle system and that performs a function for operation of the first vehicle, identifying second equipment located onboard a different, second vehicle of the vehicles in the vehicle system that performs the same function as the first equipment responsive to detecting the failure of the first equipment, and communicating data between the first vehicle and the second equipment located onboard the second vehicle for performing the function for operation of the first vehicle.

As used herein, an element or step recited in the singular and proceeded with the word “a” or “an” does not exclude plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The above description is illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A vehicle communication system comprising:
a first communication device located onboard a first vehicle in a vehicle system formed from the first vehicle and at least a second vehicle in the vehicle system; and
a second communication device located onboard the second vehicle in the vehicle system, the first and second communication devices communicatively coupled with each other via a wired connection extending between the first and second communication devices,
wherein the first and second communication devices are configured to share a security credential via the wired connection,
wherein the first and second communication devices also are configured to establish a secure wireless network between the first and second communication devices using the security credential that is shared via the wired connection.

2. The vehicle communication system of claim 1, wherein the first and second communication devices are configured to securely communicate a data signal between the first and second communication devices via the secure wireless network to control operation of the vehicle system.

3. The vehicle communication system of claim 1, wherein the wired connection comprises a multiple unit cable.

4. The vehicle communication system of claim 1, wherein the wired connection comprises a portion of a conductive portion of a route on which the vehicle system is positioned.

5. The vehicle communication system of claim 1, wherein the first and second communication devices are configured to establish the secure wireless network without the first or second communication device broadcasting identifying information about the first or second communication device or about the wireless network.

6. The vehicle communication system of claim 1, wherein, responsive to one or more additional vehicles having an additional communication device connecting with the vehicle system and with the wired connection, at least one of the first or second communication devices is configured to communicate one or more of the security credential or an updated security credential to the one or more additional communication devices via the wired connection to connect the one or more additional communication devices to the secure wireless network using the one or more of the security credential or the updated security credential.

7. A vehicle communication system comprising:
a first communication device located onboard a first vehicle in a vehicle system formed from the first vehicle and at least a second vehicle;
a second communication device located onboard the second vehicle in the vehicle system; and
a first communication path extending between the first and second communication devices and established using a first communication medium,
wherein the first and second communication devices are configured to share a security credential via the first communication path,
wherein the first and second communication devices also are configured to establish a secure second communication path between the first and second communication devices using the security credential that is shared via the first communication path, the second communication path established by the first and second communication devices using a different, second communication medium extending between the first and second communication devices.

8. The communication system of claim 7, wherein the first and second communication devices are configured to securely communicate a data signal between the first and second communication devices via the secure second communication path to control operation of the vehicle system.

9. The communication system of claim 7, wherein the security credential that is communicated via the first communication path is an encryption key.

10. The communication system of claim 7, wherein the first communication medium is a conductive connection between the first and second communication devices.

11. The communication system of claim 7, wherein the first communication path extends through and includes an off-board communication device.

12. The communication system of claim 7, wherein the second communication medium used to establish the second communication path is a wireless network.

13. The communication system of claim 7, wherein the first and second communication devices are configured to establish the secure second communication path without the first or second communication device broadcasting identifying information about the first or second communication device.

14. The communication system of claim 13, wherein the first and second communication devices are configured to establish the secure second communication path without the first or second communication devices wirelessly broadcasting (a) a network identifier of any of the first or second communication devices or (b) a network identifier of a wireless network that connects the first and second communication devices.

15. The communication system of claim 7, wherein the second communication path communicates data at one or more of faster data speeds or over larger data bandwidths than the first communication path.

16. A method for vehicle communications comprising:
communicating a security credential between communication devices onboard different vehicles in a vehicle system, the security credential communicated between the communication devices via a first communication path established using a first communication medium extending between the communication devices, the vehicle system formed from at least the vehicles having the communication devices that share the security credential;
establishing a secure second communication path between the communication devices onboard the different vehicles using the security credential that is shared via the first communication path, the second communication path established using a different, second communication medium extending between the communication devices; and
securely communicating a data signal between the communication devices via the secure second communication path to control operation of the vehicle system.

17. The method of claim 16, further comprising concurrently updating one or more of stored data or software operating on the communication devices using a data update communicated to the communication devices via the second communication path.

18. The method of claim 16, further comprising:
receiving trip data at the communication devices via the second communication path, the trip data indicating information on an upcoming trip or segment of a current trip of the vehicle system;
separately and individually determining operational settings of the vehicle systems based on the trip data, wherein the operational settings are determined separately and individually by a controller onboard each of the vehicles; and
implementing the operational settings that are separately and individually determined by the controllers onboard the vehicles to change movement of the vehicle system.

19. The method of claim 16, further comprising:
obtaining visual data from one or more cameras onboard a first vehicle of the vehicles in the vehicle system; and
communicating the visual data from the one or more cameras onboard the first vehicle to one or more of a display device or a tangible and non-transitory computer-readable memory located onboard a different, second vehicle of the vehicles in the vehicle system via the second communication path.

20. The method of claim 16, further comprising:
detecting a failure of first equipment that is located onboard a first vehicle of the vehicles in the vehicle system and that performs a function for operation of the first vehicle;
responsive to detecting the failure of the first equipment, identifying second equipment located onboard a different, second vehicle of the vehicles in the vehicle system that performs the same function as the first equipment; and
communicating data between the first vehicle and the second equipment located onboard the second vehicle for performing the function for operation of the first vehicle.
